(19) United States
(12) Patent Application Publication
(10) Pub. No.: US 2022/0032093 A1
(43) Pub. Date: Feb. 3, 2022

(54) Fresh Air Delivery Systems and Methods

(71) Applicant: James Skelton, Lawrenceville, GA (US)

(72) Inventor: James Skelton, Lawrenceville, GA (US)

(21) Appl. No.: 17/380,330

(22) Filed: Jul. 20, 2021

Related U.S. Application Data
(60) Provisional application No. 63/058,680, filed on Jul. 30, 2020.

(51) Int. Cl. A62B 18/00; A62B 23/02

(52) U.S. Cl. CPC A62B 18/003; A62B 23/02

(57) ABSTRACT

A fresh air delivery system of the present disclosure has a bottom base comprising a battery compartment and an air blower compartment and an upper cover comprising an air intake. Further, the fresh air delivery system has at least one tube extending that extends from an air blower in the air blower compartment and configured to extend to a user's face, and to a user's mouth and nostrils, and the at least one tube is configured to couple to the air blower, which delivers air to the user's mouth and nostrils.

### CROSS-REFERENCE TO RELATED APPLICATION

This application claims priority to U.S. Provisional Patent Ser. No. 62/058,680 and filed on Jul. 30, 2020, which is entitled A Cleaning and Sanitizing Air Flow System to Keep the Air Pure and Boosts the Oxygen Level Inside of the Face Masks, which is incorporated herein by reference.

### BACKGROUND

Since the virus pandemic, people have been mandated to wear face masks. This was the first experience that I had personally with wearing a face mask. It was extremely uncomfortable for even a short period of time when doing my daily errands. I could imagine how hard it was for the people who must wear them for long periods of time. Then I thought of a way to ease the discomfort of the hot sweaty mask by creating a cool, fresh continuous flow of purified air under the mask.

There are several problems with masks. First, when used for an extended period, a face mask can feel suffocating, or it may impair the breathing of the person wearing the mask. Additionally, individuals with glasses have a difficult time because wearing the face mask tends to fog their glasses, which makes it difficult for the individual to see.

Furthermore, oxygen levels under the face masks tend to be lower than is needed for an individual. Thus, wearing a face mask is not healthy for extended usage.

### BRIEF DESCRIPTION OF THE DRAWINGS

The disclosure can be better understood referencing the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a front view of an individual wearing a fresh air delivery device in accordance with an embodiment of the present disclosure.

FIG. 2 is a housing unit of the fresh air delivery device such as is shown in FIG. 1.

FIG. 3 is an exploded view of the fresh air delivery device such as is shown in FIG. 1.

FIG. 4 is a front view of an air delivery tube of the fresh air delivery system such as is shown in FIG. 1.

FIG. 5 is a back view of the air delivery tube of the fresh air delivery system such as is shown in FIG. 1.

### DETAILED DESCRIPTION

The present disclosure describes a fresh air delivery system for use with face masks in accordance with an embodiment of the present disclosure. The fresh air delivery system of the present disclosure supplies a fresh, clean, and sanitized flow of air under the face mask that is gentle for breathing and for cooling the face. In addition, it ensures that glasses do not fog when wearing the face mask.

The fresh delivery system of the present disclosure comprises a plastic case or enclosure with two compartments. In one compartment is a micro air blower. In another compartment of the enclosure is a rechargeable power supply and a printed circuit board. On the outside of the compartment is an on/off switch. Also, a lanyard may be attached to the case that is used to support the compartment from a user's neck or the device can be secured in the wearer's pocket or in any other manner. In one embodiment a clip may fit on the back of the case to be used with alternate methods of carry. The compartment comprises a removable and replaceable high efficiency particulate air (HEPA) filter that covers the top intake side of the micro air blower. Coupled to the case are flexible air tubes to carry fresh, sanitized air to fill a face mask, which helps the user breathe and cools the face area under them with a fresh gentle breeze plus avoid foggy glasses.

The fresh air delivery system is user-friendly. Furthermore, it is compact and easy to wear.

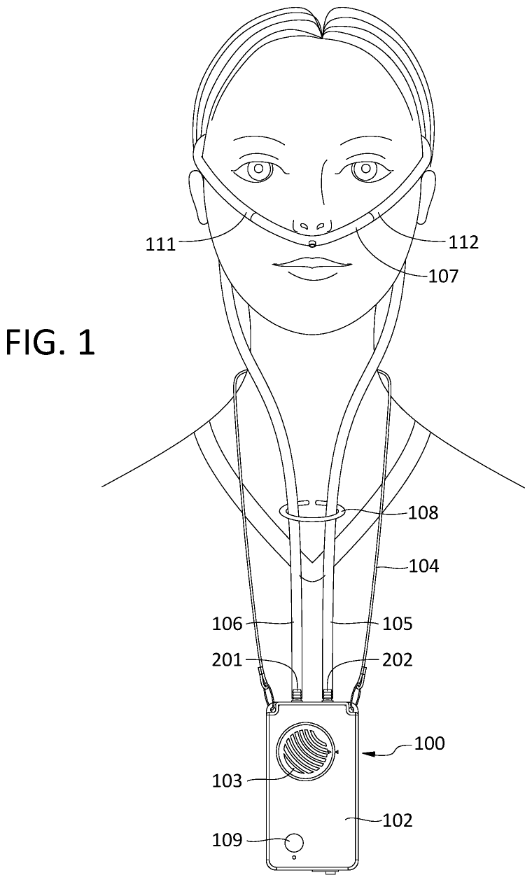

FIG. 1 is a depiction of a user 90 using a fresh air delivery system 100 of the present disclosure. The fresh air delivery system 100 comprises a case or enclosure 102. The case 102 comprises a power button 109 and a screen 103 through which air travels inward. Within the case 102 is a filter (not shown) that filters the air being drawn into the case 102.

The filtered, fresh air is diverted through the tubes 105 and 106 and is delivered to the user's mouth and nostrils. The tubes 105 and 106 traverse the user's face and attach at 111 and 112 to a nose tube assembly 107. Through the nose tube assembly 107 fresh air is delivered to the user's mouth and nostrils 93.

Note that the fresh air delivery system 100 pulls in air from the user's surroundings. The air is filtered, and a blower (not shown) blows clean, filtered air through connected tubes 92 and 92 of the user and under a face mask (not shown) at the sides. The air is fresh, clean, and sanitized to make breathing within the mask a healthier and more pleasant experience, even for extended times of wearing the face mask.

In use, the user 90 places the case 102 either on the lanyard 104 or on a clip (not shown). The case 102 may also be held in a pocket. it does not need to be on a lanyard or belt clip. The tubes 105 and 106 go into the sides of the face mask. The tubes 105 and 106 connect to the nose and mouth tube assembly 107. A clip 018 may be used to secure the air tubes 105 and 106 in a proper position. The user 90 activates the fresh air delivery system 100 by pressing the power button 109. Air is drawn into the screen 103 through a filter (not shown) and diverted to the air hoses 105 and 106, which delivers fresh, sanitized air to the user's mouth and nostrils 93.

In one embodiment, the tubes 105 and 106 are stabilized using a cinch 108. The cinch 108 is annular and wraps around the tubes 105 and 106. The cinch 108 aides in keeping the tubes 105 and 106 in position to deliver fresh, sanitized air to the user.

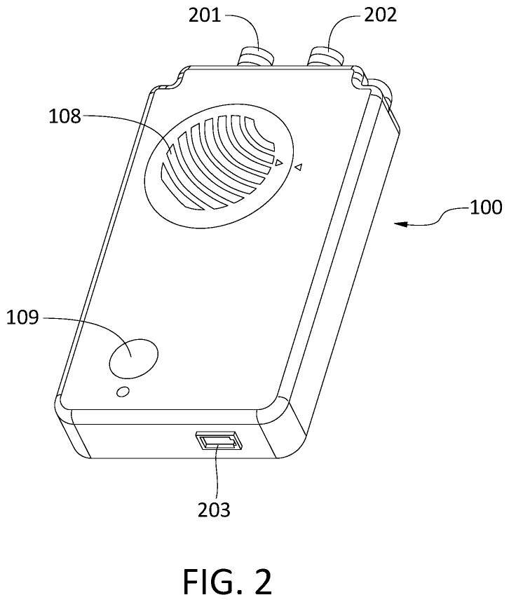

FIG. 2 is a perspective view of the case 102. The case 102 is substantially a rectangular prism. However, there may be other shapes in other embodiments. Further, the case 102 may be made of plastic materials. However, it may be made of other types of materials in other embodiments.

The case 102 comprises a universal serial bus (USB) port 203. The USB port 203 may be connected to a power source (not shown). When connected to the power source, batteries (not shown) within the case 102 are charged.

The case 102 further comprises an on/off button 109. The user 90 (FIG. 1) may depress the on/off button 109 to turn the fresh air delivery system 100 on and off.

The case 102 further comprises the screen 103. The screen 103 protects a filter (not shown) within the case 102. Air is drawn into the fresh air delivery system 100 (FIG. 1) through the screen 103 where it is pulled through the filter to sanitize the air.

Additionally, the case 103 comprises connectors 201 and 202. The connectors 201 and 202 connect to the tubes 106 and 105, respectively. Notably, the tubes 106 and 105 may be removed from case 103 for cleaning or storage purposes.

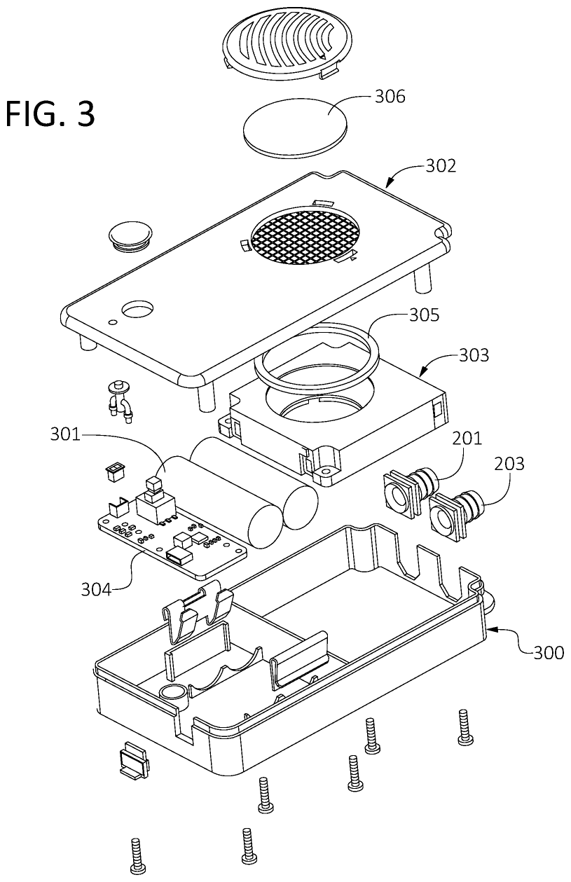

FIG. 3 is a perspective exploded view of the case 102. In this regard, the case 102 comprises a lower base 300 and an upper cover 302.

Within the base 300 there is a battery compartment 311 and an air blower compartment 312. The battery compartment 311 couples to the batteries 301 fit within the compartment 311 and couples to the positive connector 308 and the negative connector 309. The batteries 301 provide power to an air blower 303, which is positioned in the air blower compartment 312. Further, via the USB port 203, power can be supplied to the batteries 301 to charge the batteries 301.

Also, in the lower base 300 in the battery compartment 311 adjacent to the batteries 301 is a printed circuit board (PCB) 304. The PCB controls the operation of the fresh air delivery system 100.

In the air blower compartment 312, the air blower 303 is coupled to the lower base 300. The air blower 303 is configured to draw air in through the screen 103 that is coupled to the upper cover 302, the filter 306 in the upper cover 302, and the matte 307 in the upper cover 302. Note that there is an annular seal that ensures that air being drawn into the air blower 303 does not escape.

Further, in the upper cover 302 is an opening 313. The power button 109 is coupled to the opening 313 in the upper cover 302. When the user 90 (FIG. 1) desires to use the fresh air delivery system 100 (FIG. 1), the user 90 depresses the power button 109.

The lower base 300 further comprises U-shaped openings 315 and 316. The U-shaped openings 315 and 316 receive the tube connectors 203 and 201, respectively.

The upper cover 302 is coupled to the bottom base 300. In this regard, there is a plurality of fasteners 314 that couple the upper cover 302 to the bottom base 300.

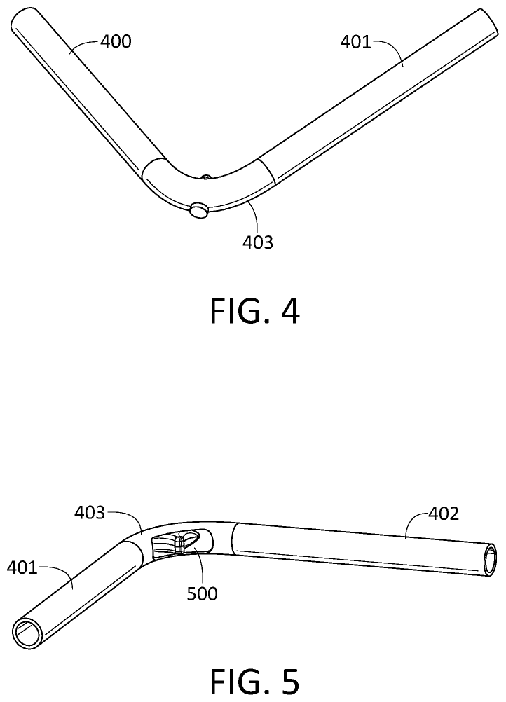

FIG. 4 is a front top view of the nose tube assembly 107. The nose tube assembly 107 comprises two opposing legs 400 and 401 formed approximately at a ninety degree angle Θ₁. The two opposing legs 400 and 401 are coupled to and/or integral with corner 403. Note that while the two opposing legs 400 and 401 are at an approximate ninety-degree angle Θ₁, other angles may be used in other embodiments.

FIG. 5 is a back view of the nose tube assembly 107. The opposing legs 401 and 402 are formed approximately at a ninety-degree angle Θ₂. The two opposing legs 400 and 401 are coupled to and/or integral with the corner 403. The corner 403 comprises an opening through which air is expelled and delivered to the mouth and nostrils 93 (FIG. 1) of a user 90 (FIG. 1). This air is delivered under a mask.

What I claim is:

1. A fresh air delivery system, comprising;
a battery compartment and an air blower compartment;
a cover comprising an air intake;
at least one tube extending that extends from an air blower in the air blower compartment and configured to extend to a user's face, and to a user's mouth and nostrils, and the at least one tube is configured to couple to the air blower, which delivers air to the user's mouth and nostrils.

2. The fresh air delivery system of claim 1, wherein batteries are coupled to connectors in the battery compartment.

3. The fresh air delivery system of claim 1, wherein a printed circuit board (PCB) is coupled to the air blower, and the PCB is electrically driven by the batteries.

4. The fresh air delivery system of claim 1, wherein the case comprises an on and off button.

5. The fresh air delivery system of claim 1, wherein the case comprises an opening.

6. The fresh air delivery system of claim 1, wherein a screen is coupled to the opening.

7. The fresh air delivery system of claim 5, wherein a filter is coupled to underneath the screen.

8. The fresh air delivery system of claim 7, wherein the air blower receives air that is pulled in through the screen and the filter, and the air is fresh and sanitized.

9. The fresh air delivery system of claim 8, wherein the air blower diverts fresh, sanitized air through at least one extending tube.

10. The fresh air delivery system of claim 9, wherein the air travels to a nose and mouth tube assembly.

11. The fresh air delivery system of claim 10, wherein the nose and mouth tube assembly comprises an opening through which the fresh, sanitized air is delivered to a user's mouth and nostrils.

12. The fresh air delivery system 1, wherein the case comprises at least one connector that connects the case to the at least one extending tube.

13. The fresh air delivery system of claim 1, wherein the case comprises a universal serial bus (USB) port.

14. The fresh air delivery system of claim 2, wherein batteries contained within the case are charged via the USB port.

15. The fresh air delivery system of claim 1, further comprising a cinch.

16. The fresh air delivery system of claim 15, wherein the cinch wraps around the at least one tube and positions the at least one tube so that the tube can deliver air to the user's mouth and nostrils.
